(19) United States
(12) Patent Application Publication
(10) Pub. No.: US 2013/0096709 A1
(43) Pub. Date: Apr. 18, 2013

(54) COMPUTING DEVICE AND METHOD FOR GENERATING ENGINEERING TOLERANCES OF A MANUFACTURED OBJECT

(71) Applicants: CHIH-KUANG CHANG, Tu-Cheng (TW); ZHONG-KUI YUAN, Shenzhen City (CN); DONG-HAI LI, Shenzhen City (CN); WEI-WEN WU, Shenzhen City (CN); NA YU, Shenzhen City (CN)

(72) Inventors: CHIH-KUANG CHANG, Tu-Cheng (TW); ZHONG-KUI YUAN, Shenzhen City (CN); DONG-HAI LI, Shenzhen City (CN); WEI-WEN WU, Shenzhen City (CN); NA YU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/590,059

(22) Filed: Aug. 20, 2012

(30) Foreign Application Priority Data
Oct. 13, 2011 (CN) 201110309825.8

(51) Int. Cl. G05B 19/4097

(52) U.S. Cl. 700/103

(57) ABSTRACT

In a method for generating engineering tolerances of a manufactured object using a computing device, the computing device sets engineering tolerances to a determined number of decimal places and stores the engineering tolerances into a storage system. The computing device receives a measured dimension of the manufactured object and a nominal dimension corresponding to the measured dimension. A number of decimal places of the nominal dimension is determined, and a pair of engineering tolerances of the manufactured object is retrieved from the storage system. The measured dimension, the nominal dimension, and the retrieved pair of engineering tolerances are displayed on a display device.

### BACKGROUND

1. Technical Field

The embodiments of the present disclosure relate to measuring manufactured objects, and particularly to a computing device and method for generating engineering tolerances of a manufactured object.

2. Description of Related Art

Measurement machines are widely used in industry to measure manufactured objects (e.g., metal castings). Measured dimensions of the manufactured objects determine if the manufactured objects meet design specifications and provide information for improvement in process control. Each measured dimension corresponds to a nominal dimension and a pair of engineering tolerances, which define a permissible range of the measured dimension. The engineering tolerances may vary for different measured dimensions. Determining engineering tolerances for plenty of measured dimensions may be time consuming and error-prone.

### BRIEF DESCRIPTION OF THE DRAWINGS

FIG. 1 is a block diagram of one embodiment of a computing device including a tolerance generating system.

FIG. 2 is a block diagram of one embodiment of function modules of the tolerance generating system in FIG. 1.

FIG. 3 is a flowchart of one embodiment of a method for generating engineering tolerances of a manufactured object using the computing device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

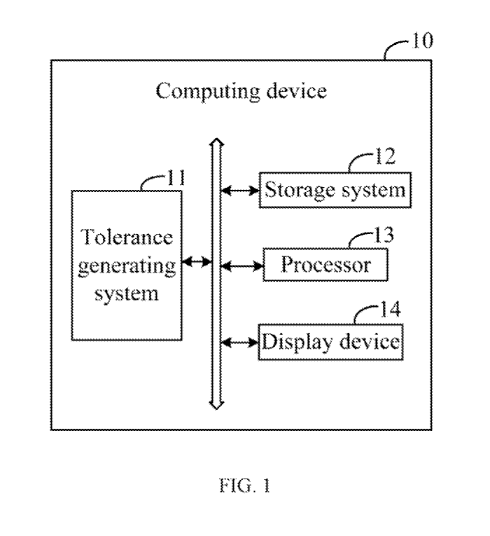

FIG. 1 is a block diagram of one embodiment of a computing device 10. In the embodiment, the computing device 10 includes a tolerance generating system 11 that generates engineering tolerances of a manufactured object (not shown). The manufactured object may be a molded part, such as a metal casting, for example. The computing device 10 further includes a storage system 12, at least one processor 13, and a display device 14. The storage system 12 may be a dedicated memory, such as an erasable programmable read only memory (EPROM), a hard disk driver (HDD), or flash memory. In some embodiments, the storage system 12 may also be an external storage device, such as an external hard disk, a storage card, or other data storage medium.

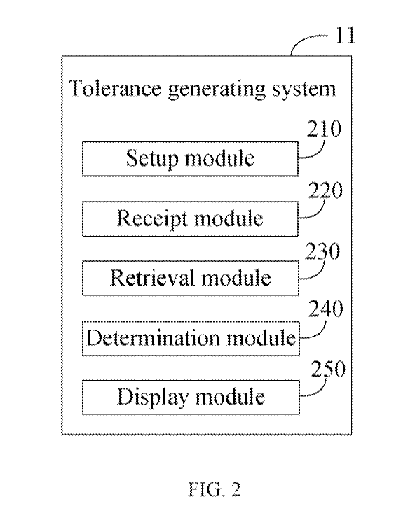

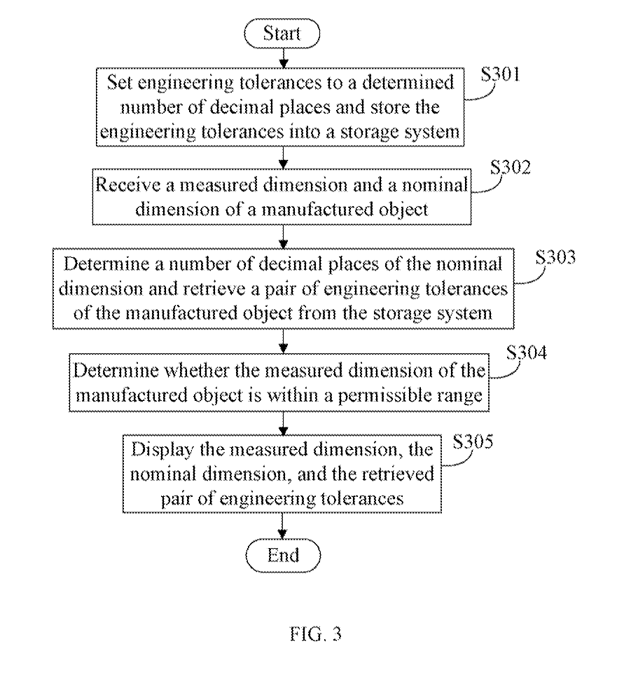

FIG. 2 is a block diagram of one embodiment of function modules of the tolerance generating system 11 in FIG. 1. The tolerance generating system 11 includes a setup module 210, a receipt module 220, a retrieval module 230, a determination module 240, and a display module 250. The modules 210-250 may comprise computerized code in the form of one or more programs that are stored in the storage system 12. The computerized code includes instructions that are executed by the at least one processor 13, to provide the aforementioned functions of the tolerance generating system 11. A detailed description of the functions of the modules 210-250 is given below and in reference to FIG. 3.

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of a non-transitory computer-readable medium include CDs, DVDs, flash memory, and hard disk drives.

FIG. 3 is a flowchart of one embodiment of a method for generating engineering tolerances of a manufactured object using the computing device 10 in FIG. 1. Depending on the embodiment, additional steps may be added, others removed, and the ordering of the steps may be changed.

In step S301, the setup module 210 sets engineering tolerances to a determined number of decimal places and stores the engineering tolerances into the storage system 12. Decimal place is the number of digits to the right of a decimal point. For example, 0.8 is one decimal place. 0.08 is two decimal places. 0.008 is three decimal places. In one embodiment, the setup module 210 sets a pair of engineering tolerances including an upper tolerance and a lower tolerance for each number of decimal places. For a specific number of decimal places (e.g., two decimal places), the lower tolerance may be an opposite number of the upper tolerance. That is, an absolute value of the lower tolerance is equal to an absolute value of the upper tolerance, and a sign of the lower tolerance is opposite to a sign of the upper tolerance. For example, for two decimal places, the upper tolerance can be 0.08 and the lower tolerance can be −0.08. Depending on the embodiment, the upper tolerance and the lower tolerance of a specific number of decimal places may be different. For example, for two decimal places, the upper tolerance can be 0.04, and the lower tolerance can be −0.03.

In one embodiment, the setup module 210 sets engineering tolerances for one decimal place through five decimal places. For one decimal place, the engineering tolerances can be ±0.1 (an upper tolerance 0.1 and a lower tolerance −0.1). For two decimal places, the engineering tolerances can be ±0.08 (an upper tolerance 0.08 and a lower tolerance −0.08). For three decimal places, the engineering tolerances can be ±0.06 (an upper tolerance 0.06 and a lower tolerance −0.06). For four decimal places, the engineering tolerances can be ±0.04 (an upper tolerance 0.04 and a lower tolerance −0.04). For five decimal places, the engineering tolerances can be ±0.02 (an upper tolerance 0.02 and a lower tolerance −0.02). The setup module 210 may set a pair of default tolerances of the manufactured object. For example, the setup module 210 sets a pair of default tolerances ±0.05 including a default upper tolerance 0.05 and a default lower tolerance −0.05.

In step S302, the receipt module 220 receives a measured dimension of the manufactured object (e.g., a measured diameter of a shaft of the manufactured object) and a nominal dimension corresponding to the measured dimension. In one embodiment, the measured dimension of the manufactured object is obtained by a coordinate measuring machine (CMM) and stored in the storage system 12. The nominal dimension is a theoretical dimension of the manufactured object. The nominal dimension may be entered by a user (e.g., entered by the user via a keyboard connected to the computing device 10) or pre-stored in the storage system 12. In one example, the measured dimension is 8.7915 and the nominal dimension is 8.7900. The unit of the measured dimension and the nominal dimension may be in millimeters.

In step S303, the retrieval module 230 determines a number of decimal places of the nominal dimension. According to the number of decimal places of the nominal dimension, the retrieval module 230 retrieves a pair of engineering tolerances of the manufactured object corresponding to the measured dimension from the storage system 12. In one example, the number of decimal places of the nominal dimension is 1 and the engineering tolerances for one decimal place are set as ±0.1. Accordingly, the retrieval module 230 retrieves the engineering tolerances ±0.1 as the engineering tolerances of the manufactured object corresponding to the measured dimension. In one embodiment, the retrieval module 230 may retrieve the pair of default tolerances if no engineering tolerances for the number of decimal places of the nominal dimension are stored in the storage system 12.

In step S304, the determination module 240 determines whether the measured dimension of the manufactured object is within a permissible range defined by the nominal dimension and the retrieved pair of engineering tolerances (e.g., 8.7900±0.04 mm) In one example, the measured dimension is 8.7915, the nominal dimension is 8.7900, and the retrieved pair of engineering tolerances of the measured dimension is ±0.04. The permissible range defined by the nominal dimension and the retrieved pair of engineering tolerances is between 8.7500 and 8.8300. Therefore, the measured dimension is within the permissible range.

In step S305, the display module 250 displays the measured dimension, the nominal dimension, and the retrieved pair of engineering tolerances on the display device 14. The display module 250 may further display a result that indicates whether the measured dimension is within the permissible range defined by the nominal dimension and the retrieved pair of engineering tolerances on the display device 14.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method for generating engineering tolerances of a manufactured object being executed by a processor of a computing device, the method comprising:
setting engineering tolerances to a determined number of decimal places, and storing the engineering tolerances into a storage system of the computing device;
receiving a measured dimension of the manufactured object and a nominal dimension corresponding to the measured dimension;
determining a number of decimal places of the nominal dimension, and retrieving a pair of engineering tolerances of the manufactured object corresponding to the measured dimension from the storage system according to the number of decimal places of the nominal dimension; and
displaying the measured dimension, the nominal dimension, and the retrieved pair of engineering tolerances on a display device of the computing device.

2. The method of claim 1, further comprising
determining whether the measured dimension of the manufactured object is within a permissible range defined by the nominal dimension and the retrieved pairs of engineering tolerances.

3. The method of claim 2, further comprising
displaying, on the display device, a result that indicates whether the measured dimension is within the permissible range defined by the nominal dimension and the retrieved pair of engineering tolerances.

4. The method of claim 1, wherein the measured dimension of the manufactured object is obtained by a coordinate measuring machine.

5. The method of claim 1, wherein the engineering tolerances for each number of decimal places comprise an upper tolerance and a lower tolerance, and the lower tolerance is an opposite number of the upper tolerance.

6. A computing device, comprising:
a storage system;
at least one processor; and
a tolerance generating system comprising one or more programs that are stored in the storage system and executed by the at least one processor, the one or more programs comprising instructions to:
set engineering tolerances to a determined number of decimal places, and store the engineering tolerances into the storage system;
receive a measured dimension of the manufactured object and a nominal dimension corresponding to the measured dimension;
determine a number of decimal places of the nominal dimension, and retrieve a pair of engineering tolerances of the manufactured object corresponding to the measured dimension from the storage system according to the number of decimal places of the nominal dimension; and
display the measured dimension, the nominal dimension, and the retrieved pair of engineering tolerances on a display device of the computing device.

7. The computing device of claim 6, wherein the one or more programs further comprise instructions to:
determine whether the measured dimension of the manufactured object is within a permissible range defined by the nominal dimension and the retrieved pairs of engineering tolerances.

8. The computing device of claim 7, wherein the one or more programs further comprise instructions to:
display, on the display device, a result that indicates whether the measured dimension is within the permissible range defined by the nominal dimension and the retrieved pair of engineering tolerances.

9. The computing device of claim 6, wherein the measured dimension of the manufactured object is obtained by a coordinate measuring machine.

10. The computing device of claim 6, wherein the engineering tolerances for each number of decimal places comprise an upper tolerance and a lower tolerance, and the lower tolerance is an opposite number of the upper tolerance.

11. A non-transitory computer-readable storage medium storing a set of instructions, the set of instructions capable of being executed by a processor of a computing device to implement a method for generating engineering tolerances of a manufactured object, the method comprising:
setting engineering tolerances to a determined number of decimal places, and storing the engineering tolerances into a storage system of the computing device;
receiving a measured dimension of the manufactured object and a nominal dimension corresponding to the measured dimension;
determining a number of decimal places of the nominal dimension, and retrieving a pair of engineering tolerances of the manufactured object corresponding to the measured dimension from the storage system according to the number of decimal places of the nominal dimension; and
displaying the measured dimension, the nominal dimension, and the retrieved pair of engineering tolerances on a display device of the computing device.

12. The storage medium of claim 11, wherein the method further comprises:
determining whether the measured dimension of the manufactured object is within a permissible range defined by the nominal dimension and the retrieved pairs of engineering tolerances.

13. The storage medium of claim 12, wherein the method further comprises:
displaying, on the display device, a result that indicates whether the measured dimension is within the permissible range defined by the nominal dimension and the retrieved pair of engineering tolerances.

14. The storage medium of claim 11, wherein the measured dimension of the manufactured object is obtained by a coordinate measuring machine.

15. The storage medium of claim 11, wherein the engineering tolerances for each number of decimal places comprise an upper tolerance and a lower tolerance, and the lower tolerance is an opposite number of the upper tolerance.
